(19) United States
(12) Patent Application Publication
(10) Pub. No.: US 2018/0089783 A1
(43) Pub. Date: Mar. 29, 2018

(54) SYSTEM FOR A VEHICLE FOR HIRE SERVICE

(71) Applicant: Khalid A. Manzoor, Bay Shore, NY (US)

(72) Inventor: Khalid A. Manzoor, Bay Shore, NY (US)

(21) Appl. No.: 15/279,753

(22) Filed: Sep. 29, 2016

(51) Int. Cl. G06Q 50/30; G08G 1/00; G06Q 10/02; G06Q 50/18

(52) U.S. Cl. CPC G06Q 50/30; G06Q 50/188; G06Q 10/02; G08G 1/202

(57) ABSTRACT

A system for a vehicle for hire service that embodies a computer-implemented method for users to reserve vehicles whenever or wherever by embodying vehicle for hire trip reservations in a recorded message. The computer-implemented method enables a user to request a trip reservation including a pick-up location/drop off destination and selectively set various trip parameters that are incorporated in the recorded message. The computer-implemented method enables trip information to be managed by the user through their user interface before transmitting the recorded message to a dispatcher component adapted to assign a driver based on in part the pick-up location.

### BACKGROUND OF THE INVENTION

The present invention relates to vehicle for hire services and, more particularly, to a system for a vehicle for hire service.

The quality of vehicle for hire service has gone down the drain in the last few years, which have caused a lot of dissatisfaction among customers. At the heart of the dissatisfaction is the current interface between the service providers and the consumer, the passenger, and the internal management of the service provider's resources when attempting to provide their services to the passenger. Namely, the passenger caller-dispatcher model invites communication breakdowns between the passenger caller and the actual drivers, who must rely on the dispatcher to efficiently comprehend the information transmitted by the passenger caller.

Furthermore, current vehicle for hire software applications' provide a user interface with drawbacks, further undermining customer satisfaction and management of the service provider's resources. Current transportation networking company's software applications have hidden surge charges, and fees. They may advertise black car service, but the service is below the expectations. As a result, current systems are outdated and facilitate poor customer service.

As can be seen, there is a need for a system for a vehicle for hire service that embodies a computer-implemented method for users to reserve vehicles whenever or wherever they want by use of recorded messages, and wherein the system is based on reservations with no hidden surge charges.

### SUMMARY OF THE INVENTION

In one aspect of the present invention, a system for a vehicle for hire service embodies a computer implemented method including providing a plurality of drivers; providing a trip reservation functionality through a user interface, wherein the trip reservation prompts a user to provide a pick-up location and a drop off destination through a recorded message that embodies the trip reservation; providing a dispatcher component configured to assign an associated driver of the plurality of drivers to each trip reservation based in part on the pick-up location; and the user interface is configured to store, replay, delete and transmit the recorded message to the dispatcher component.

In another aspect of the present invention, the system for a vehicle for hire service a computer implemented method including providing a plurality of drivers; providing a trip reservation functionality through a user interface, wherein the trip reservation prompts a user to provide a pick-up location and a drop off destination through a recorded message that embodies the trip reservation and at least one trip parameter; providing a dispatcher component configured to assign an associated driver of the plurality of drivers to each trip reservation based in part on the pick-up location; and the user interface is configured to store, replay, delete and transmit the recorded message to the dispatcher component, wherein the at least one trip parameter includes a type of vehicle, wherein the at least one trip parameter includes round-trip requests, associated event information, and fare negotiations, wherein the user interface is configured to track a current location of the associated driver, wherein the user interface is configured to relay communications to the associated driver, and wherein the user interface is configured to relay payment to the associated driver.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention;

FIG. 2 is a schematic view of an exemplary embodiment of the present invention;

FIG. 3 is a schematic view of an exemplary embodiment of the present invention;

FIG. 4 is a schematic view of an exemplary embodiment of the present invention;

FIG. 5 is a schematic view of an exemplary embodiment of the present invention;

FIG. 6 is a schematic view of an exemplary embodiment of the present invention;

FIG. 7 is a schematic view of an exemplary embodiment of the present invention;

FIG. 8 is a schematic view of an exemplary embodiment of the present invention;

FIG. 9 is a schematic view of an exemplary embodiment of the present invention;

FIG. 10 is a schematic view of an exemplary embodiment of the present invention;

FIG. 11 is a schematic view of an exemplary embodiment of the present invention;

FIG. 12 is a schematic view of an exemplary embodiment of the present invention;

FIG. 13 is a schematic view of an exemplary embodiment of the present invention;

FIG. 14 is a schematic view of an exemplary embodiment of the present invention;

FIG. 15 is a schematic view of an exemplary embodiment of the present invention; and

FIG. 16 is a schematic view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for a vehicle for hire service that embodies a computer-implemented method for users to reserve vehicles whenever or wherever they want by use of recorded messages. The computer-implemented method enables a user to request a trip reservation including a pick-up location/drop off destination and selectively set various trip parameters, wherein the trip reservation is embodied in a recorded message. The computer-implemented method enables trip information to be managed by the user through their user interface, including replaying, transmitting or deleting the recorded message.

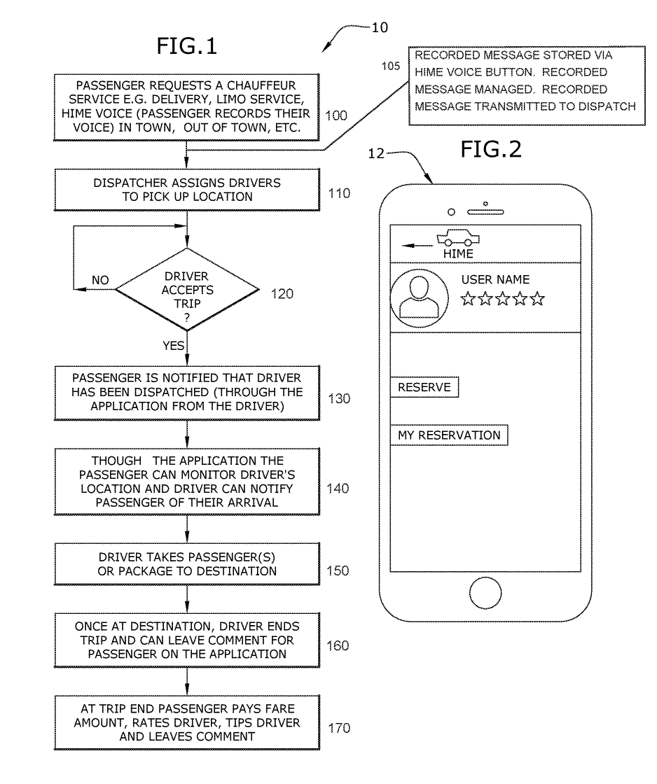

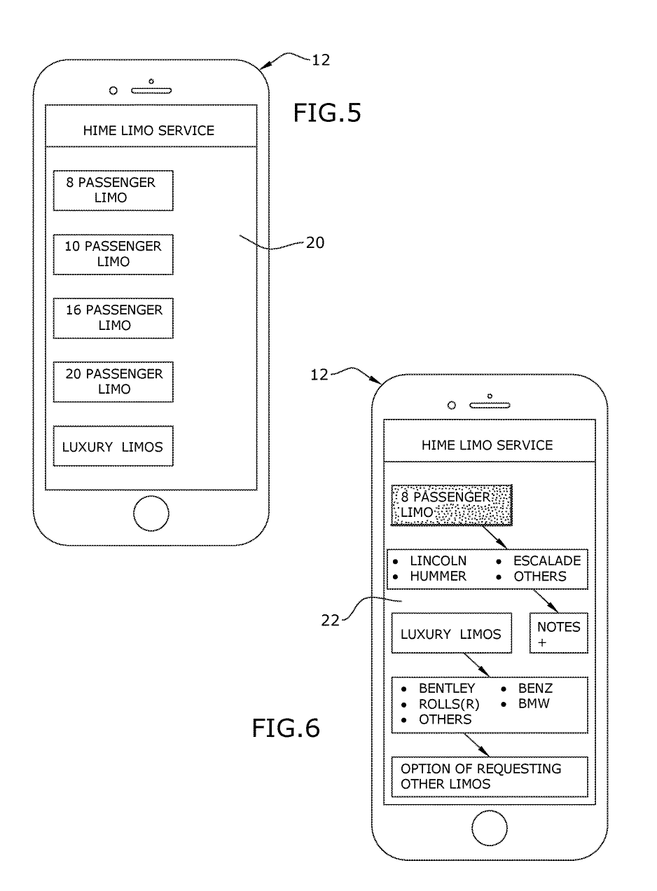

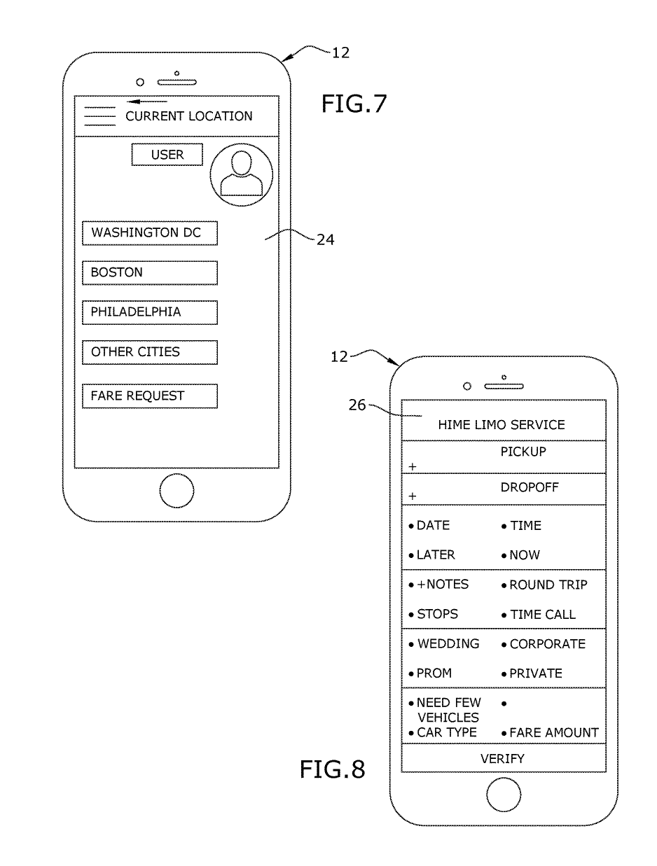

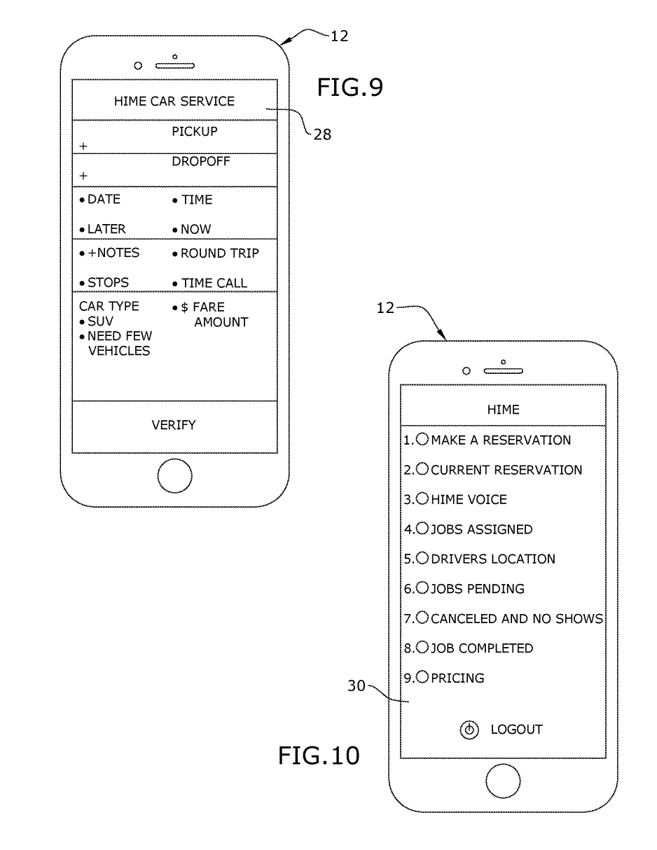

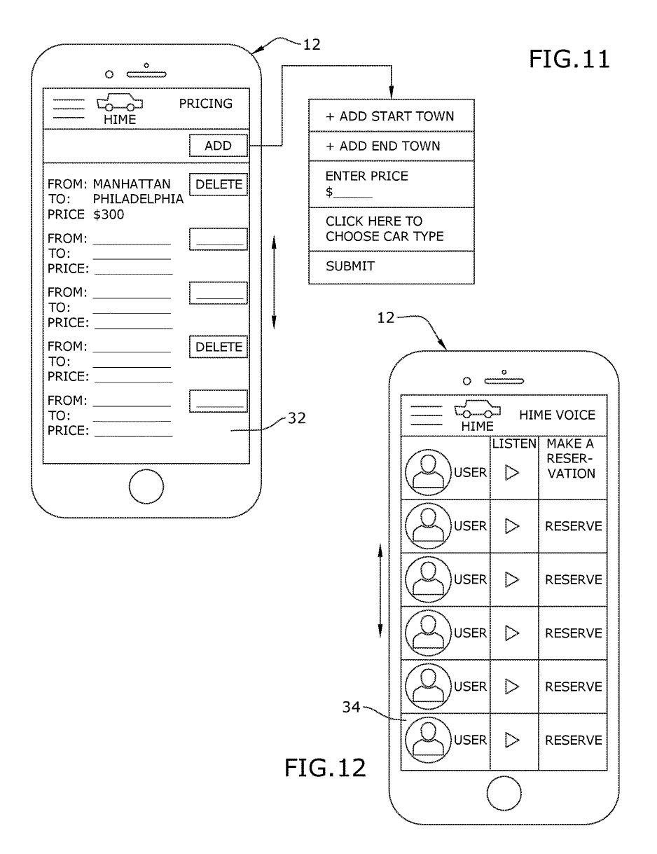

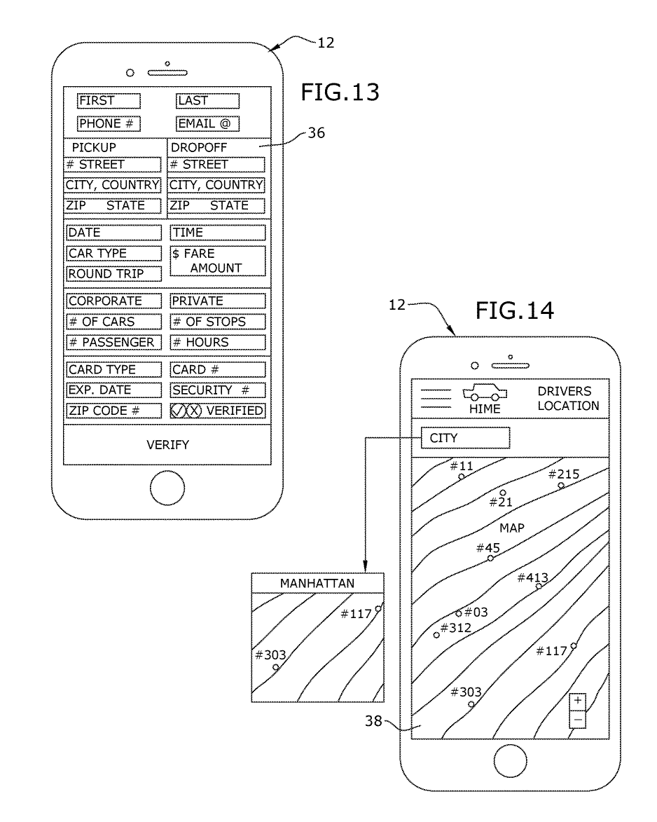

Referring to FIGS. 1 through 16, the present invention may include at least one computer 12 with a user interface 14. The computer 12 may include at least one processing unit coupled to a form of memory. The computer 12 may include, but not limited to, a desktop, a laptop, and any smart device, such as, a tablet, smart phone, smart watch and the like. The computer 12 includes a program product including a machine-readable program code for causing, when executed, the computer 12 to perform steps. The program product may include software which may either be loaded onto the computer or accessed by the computer 12. The loaded software may include an application on a smart device. The software may be accessed by the computer 12 using a web browser. The computer 12 may access the software via the web browser using the internet, extranet, intranet, host server, internet cloud and the like.

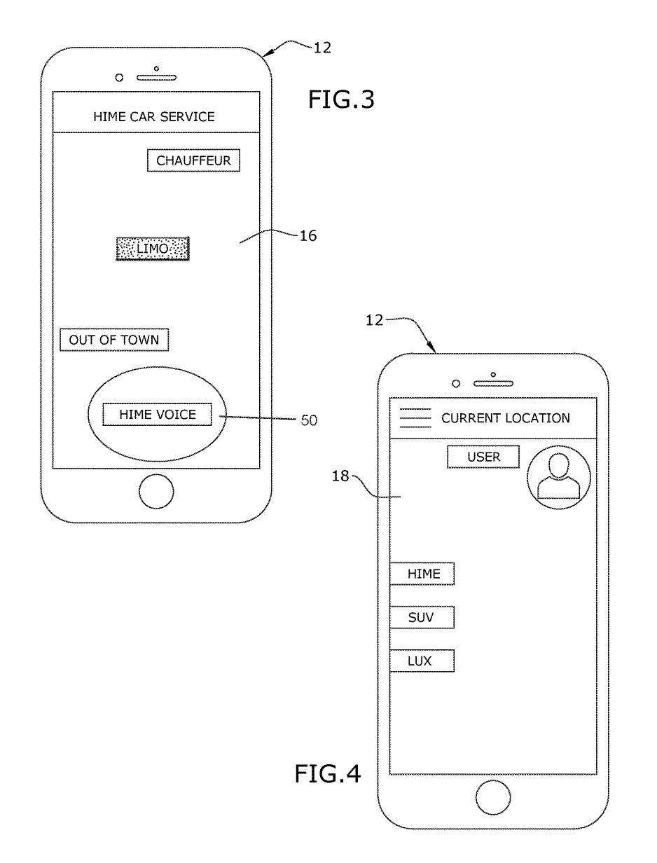

The software application may include initial login and account management functionality. A method of using the present invention may include the following. Using the software application driven system 10 and the representations made through the user interface 14, a user may click on the ‘Reserve’ representation, as illustrated in FIG. 2, so as to make a trip reservation including a pick-up location/drop off destination and trip parameters, in step 100. The trip parameters may include, but not limited to, type of vehicle/service, current location specifics, specified times and future dates, notes, round-trip requests, associated event information, and fare negotiations, as illustrated in FIGS. 3-9 and 11. The embodiments of the user face as represented to the user-passenger, the dispatcher component and the driver (or three different, respectively, application thereof) may include, but not be limited to an options screen 16, a limo selection screen 18, a general reservation screen 20, a limo reservation screen 22, a driver information screen 24, a detailed limo option screen 26, a detailed car option screen 28, a driver main screen 30, a pricing screen 32, a recorded message 34 management screen, a passenger information screen 36, a driver location screen 38, a taxi location screen 40, and an invoice screen 42.

Then the user may record a recorded message 34 embodying the trip reservation by engaging the hime voice button 50, as illustrated in FIG. 3, and thereafter manage the recorded message 34, in step 105. The hime voice button 50 may take the user to a first screen to record the trip reservation embodied recorded message 34 upon depressing an engagement button. Upon releasing the engagement button, the present invention shifts to a second screen, wherein the user may manage the recorded message 34, including but not limited to reviewing the recorded message 34, deleting the recorded message 34, and transmitting the recorded message 34.

Then a dispatcher receives and reviews the recorded message 34, assigning an associated driver nearest to the user's pick up location, alerting the driver to said location of the user, in step 110.

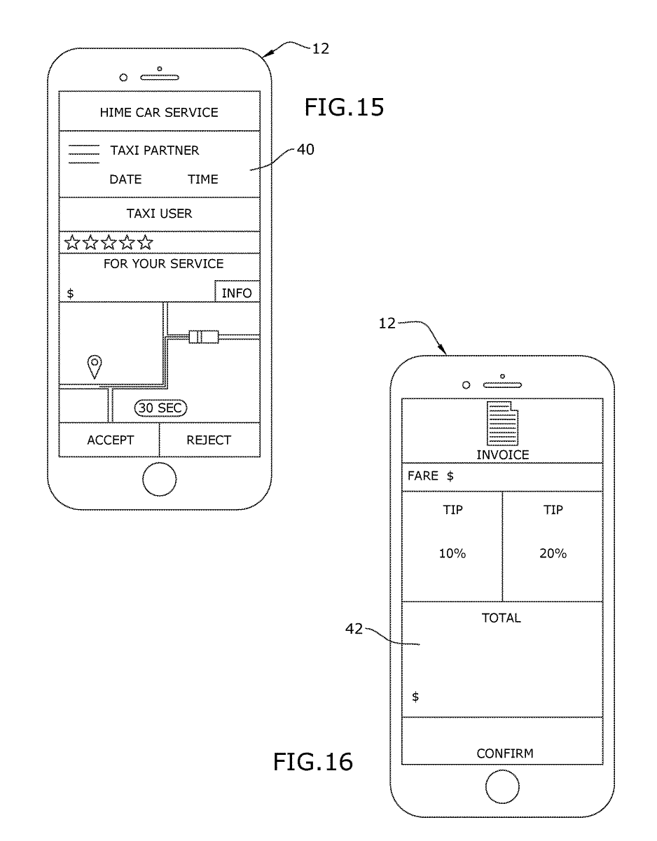

Then the associated driver confirms acceptance of the trip request and related trip parameters, in step 120. The passenger-user is then notified through the user interface 14 that the associated driver has been dispatched, in step 130. Additional trip information can be managed by the user through their interface 14, including but not limited to current and past reservations, stored recorded messages 34 so that users can transmit old but relevant trip reservation embodied therein, associated driver's current location, etc., as illustrated in FIGS. 10 and 12-14. Through the software application system 10, the user may monitor the driver's location and the driver can notify passenger of their arrival, in step 140. When the driver is at the pick-up location they start the trip, and at the drop off destination the associated driver ends trip when passenger or package is dropped off, in step 150. Once the trip ends, the associated driver can leave a comment for the passenger on the software application, in step 160. In step 170, the passenger can pay the fare, rate and tip the associated driver, and leave a comment thereto, as illustrated in FIGS. 15 and 16.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer implemented method for facilitating a vehicle for hire service without a flesh and blood dispatcher, comprising the steps of:
providing a plurality of drivers;
providing a trip reservation functionality through a user interface, wherein the trip reservation prompts a user to provide a pick-up location and a drop off destination through a recorded message that embodies the trip reservation;
providing a dispatcher component configured to assign an associated driver of the plurality of drivers to each trip reservation based in part on the pick-up location; and
the user interface is configured to store, replay, delete and transmit the recorded message to the dispatcher component.

2. The method of claim 1, wherein the trip reservation includes at least one trip parameter.

3. The method of claim 2, wherein the trip parameter includes a type of vehicle.

4. The method of claim 2, wherein the at least one trip parameter includes round-trip requests, associated event information, and fare negotiations.

5. The method of claim 1, wherein the user interface is configured to track a current location of the associated driver.

6. The method of claim 1, wherein the user interface is configured to relay communications to the associated driver.

7. The method of claim 1, wherein the user interface is configured to relay payment to the associated driver.

8. A computer implemented method for facilitating a vehicle for hire service without a flesh and blood dispatcher, comprising the steps of:
providing a plurality of drivers;
providing a trip reservation functionality through a user interface, wherein the trip reservation prompts a user to provide a pick-up location and a drop off destination through a recorded message that embodies the trip reservation and at least one trip parameter;
providing a dispatcher component configured to assign an associated driver of the plurality of drivers to each trip reservation based in part on the pick-up location; and
the user interface is configured to store, replay, delete and transmit the recorded message to the dispatcher component, wherein the at least one trip parameter includes a type of vehicle, wherein the at least one trip parameter includes round-trip requests, associated event information, and fare negotiations, wherein the user interface is configured to track a current location of the associated driver, wherein the user interface is configured to relay communications to the associated driver, and wherein the user interface is configured to relay payment to the associated driver.
